(19) United States
(12) Patent Application Publication
(10) Pub. No.: US 2014/0167726 A1
(43) Pub. Date: Jun. 19, 2014

(54) ENERGY STORAGE ARRANGEMENT AND ALTERNATING LOAD CONSUMER

(71) Applicants: Peter Eckert, Erlangen (DE); Reinhard Hoffmann, Erlangen (DE); Wolfgang Hörger, Hausen (DE); Karsten Rechenberg, Dormitz (DE)

(72) Inventors: Peter Eckert, Erlangen (DE); Reinhard Hoffmann, Erlangen (DE); Wolfgang Hörger, Hausen (DE); Karsten Rechenberg, Dormitz (DE)

(21) Appl. No.: 14/131,623

(22) PCT Filed: Jun. 27, 2012
(86) PCT No.: PCT/EP2012/062424

§ 371 Date: Jan. 8, 2014

(30) Foreign Application Priority Data
Jul. 8, 2011 (EP) 11173322.6

(51) Int. Cl. H02M 3/158

(52) U.S. Cl. CPC H02M 3/1582
USPC 323/311

(57) ABSTRACT

An energy storage arrangement for an electric load which exchanges electrical power with an energy supply network, has two connections in the form of a load to the parallel circuit and for the energy supply network, a converter which is switched between the connections, is voltage-impressed and contains an energy store. The energy store is designed to store an energy amount which exceeds that necessary for the regular operation of the converter by a multiple. An arc furnace which is fed as a load from an energy supply network contains such an energy storage arrangement.

### CROSS REFERENCE TO RELATED APPLICATIONS

This application is based on and hereby claims priority to International Application No. PCT/EP2012/062424 filed on Jun. 27, 2012 and European Application No. 11173322.6 filed on Jul. 8, 2011, the contents of which are hereby incorporated by reference.

### BACKGROUND

The invention relates to an energy storage arrangement for an electric load which exchanges electrical power with an energy supply network and an alternating load consumer as such an electric load.

An electric load connected to an energy supply network or fed by it is, for example, an industrial plant connected to a medium-voltage power grid. Certain industrial plants, such as for example, steelworks, rolling mills or smelting plants, in particular their electric, e.g. arc furnaces, have a high electrical power or energy requirement which must be met by the energy supply network. Today static converters (VSC, voltage source converters) with a direct connection to the energy supply network, e.g. a medium voltage or high voltage network, are increasingly used for such industrial plants. The converter is connected in parallel both to the load and to the energy supply network. Certain consumers in such plants, e.g. arc furnaces or rolling mills, are also called alternating load consumers.

For example, when operating an arc furnace there are time intervals in which the requisite electrical instantaneous power fluctuates greatly (so-called flicker) at very short time intervals, namely in the range of milliseconds. In addition, over longer time periods of for example, approx. 30-60 minutes—namely of the process time of an arc furnace for steel melt—a process results in which the average power of the load to be consumed is relatively predictable and only fluctuates comparatively slowly, namely in the minute range. This often widely fluctuating power requirement of the loads puts a significant strain on the energy supply networks and leads to high costs for the power supply companies, which in turn are passed on to the operator of the load. A decrease in regenerative electrical energy from the energy supply network is not actually possible because of the high power peaks.

Another problem arises in electric loads which are sensitive to voltage fluctuations in the energy supply network, for example semiconductor fabrication plants. Here the supply voltage of the energy supply network must be stabilized on the load side. The same applies to the stabilization of electricity-generating synchronous machines as loads (energy source, negative load), above all in the event of a fault in the machine, for example in the case of load shedding. Here too where the machine is connected to the supply network, the energy still generated in the latter until the activation of the machine must be discharged. Today such energy is converted into heat on shunt resistors.

The power fluctuations in such industrial plants, such as steelworks, for example, are currently usually relayed to the energy supply network.

There have long been reactive-power compensation systems for the reactive power fluctuations of industrial plants. Modern converters (VSC) based, for example, on IGBT technology can already provide compensation for reactive power. However, only a very small amount of compensation is provided for active power fluctuations.

In principle, battery storage systems are also known for high energy amounts, but cannot be used for the predefined high outputs or peaks, for example required by an arc furnace, with a simultaneously high energy storage capacity.

The use of double layer capacitors (DLC, also known as “Ultracaps” from EPCOS) as so-called supercapacitors in streetcar operation is known from WO 2009/121656 A2. These then serve as an energy store for small amounts of energy.

With the product “DynaPeaQ®”, ABB offers an energy store based on Li-ion cells in conjunction with a medium voltage converter which has a high energy storage capacity. The changes in output are moderate in this respect and the permissible load cycles limited.

To improve the voltage quality for sensitive consumers, a so-called “dynamic voltage restorer (DVR)” storage system is also known, which uses the energy stored in batteries via a transformer to the effect that pending mains voltage fluctuations are compensated by an additive voltage component at an optimum value.

In principle, energy storage systems are therefore known. However, the known systems relate either to a high power consumption peak such as, for example, the aforementioned double layer capacitors with a small amount of stored energy or to a high amount of stored energy with a moderate power consumption peak and a relatively small number of load cycles.

### SUMMARY

One possible object is to improve the power exchange of an energy supply network with an electric load, and to specify an improved arc furnace.

The inventors propose an energy storage arrangement. This has two connections which serve for the parallel connection to the load and to the energy supply network. A voltage-impressed converter containing an energy store is connected between the two connections. The topology thus corresponds to the conventional activation of a load on a network with the aid of a VSC. As proposed, however, the energy store in the converter is designed to store an energy amount which exceeds that necessary for the regular operation of the converter by a multiple.

The regular, i.e. traditional operation of an aforementioned converter known hitherto is characterized in that the energy store is designed such that it can only accept energy to commutate the valves of the converter, i.e. for example to operate the IGBTs (Insulated Gate Bipolar Transistors) in the converter. The energy store is then a conventional intermediate circuit capacitor which usually has a capacity in the millifarad range.

The proposed energy store attains a much larger storage capacity. The proposed energy store in a comparable converter is then e.g. in the farad range and therefore distinguishes itself from the conventional energy store by a factor of several tens or hundreds to several thousands or more. The energy store is thus used to receive a much larger amount of active and/or reactive energy or power. In other words, the energy store therefore contains an amount of energy which is substantially greater than that which would be required for about one switching cycle of the converter.

A previous traditional converter with a traditional intermediate circuit capacitor is therefore only in a position to store approximately the power accruing in the converter in a single mains period. However, only a very small amount of capacity, i.e. imperceptible in plant operation, is available for the intermediate storage of active power. Thanks to the considerably greater energy store, power or energy can also be stored there which is perceptible i.e. is relevant in the interaction of network and load. Corresponding active power is therefore stored in the converter for considerably more than one mains period. Mains periods are approximately in the range of 20 milliseconds. The perceptible storage capacity of the proposed energy store extends over milliseconds, seconds or even minutes. A powerful energy store is therefore assigned to the converter or configured for it which can be used for the aforementioned problems. On the one hand then, this energy store has high output dynamics and on the other hand, a high storage capacity for a large number of load cycles.

The proposals are based on the recognition that in the meantime energy stores are available which can be used for the perceptible compensation of active power in particular and which are also available to a usable extent or in useable technology.

An energy storage arrangement is therefore proposed which serves to store and discharge electrical energy, which on the one hand permits a high power consumption peak and stores a large amount of energy. Energy stores which are in a position to supply and receive large amounts of power for a short time are integrated into the converter (VSC). Thus, the compensation of reactive and active power fluctuations is enabled on a scale relevant to the load and the network. Direct integration of the energy store therefore takes place, in particular also of a short-term energy store into the converter as its modular and customized expansion. In this way, a significant improvement of the network connection of the load or systems through to mains compensation is possible in a simple manner.

An important part lies in the use of capacities in the order of magnitude of actual energy stores, in other words, in the high farad range instead of pure intermediate circuit capacities for the commutation of the IGBT in the millifarad range. A balance of active power fluctuations can be realized in a simple manner with the energy directly stored in the converter. On the one hand, this can be used to significantly reduce the peak load consumption of loads connected in parallel to the converter, such as for example, arc furnaces.

Apart from the actual converter functionality, the converter can thus also assume the aforementioned compensation functions for active and reactive power on account of the high energy storage capacity.

An additional advantage arises from the perspective of the energy supply network: at idling speed on the load side the converter can also be used to compensate for faster load fluctuations in the supply network. I.e. active power from the network can be stored temporarily in the energy store. Reactive power compensation from the network is possible to a relevant extent. In this way, the network quality is improved, which can bring about significant operational relief and/or savings for an energy supply company.

With the option of also using the energy store for the network stabilization of an energy supply company, it obtains an additional function: it can be used as a standby store by the energy supplier if necessary.

To the same extent, a temporary emergency power supply via such a system is possible for a load with a sensitive power supply. Here too an additional standby function on the network side is again conceivable.

In a preferred embodiment the energy store contains various partial stores, the partial stores having different charging speeds and/or storage capacities from each other. Energy stores are currently either designed for a high power output with a low storage volume or for a high storage volume with a low or medium power output. In the case of batteries with a high storage density, the number of charging cycles also plays a role, a higher number of charging cycles being possible with only slight discharge. With a modular design of partial stores, e.g. in a cascaded arrangement of different storage modules such as capacitors, double layer capacitors and batteries (for example, in Li-ion technology), the advantages of each individual partial store are combined in a single energy store. It is important that the optimum load profile is provided for the following storage medium, in other words the partial store, via respective charging or discharging devices assigned to the partial store.

For example, there are two partial stores, one of which has a comparatively high charging speed and low charging capacity, while the other has a low charging speed and a high storage capacity. Both partial stores can thus operate for certain subtasks in energy supply or in energy compensation with regard to the network or the load.

In a variant of this embodiment as the first partial store, the energy store contains a conventional storage capacitor and as the second partial store a background store. The storage capacitor is designed to store an energy amount which is in the range of that necessary for the regular operation of the converter. The background store is designed in such a way that it serves to store an energy amount which exceeds the energy amount in the storage capacitor by a multiple. In other words, a conventional storage capacitor in the converter is expanded or increased by a multiple by an additional energy store in the form of the background store with regard to its storage capacity.

In an additional variant of the aforementioned embodiment, one of the partial stores is directly connected in the converter. A charging circuit is then connected between this partial store and an additional partial store. This controls an energy flow between the two partial stores. For example, the aforementioned storage capacitor is directly integrated into the converter as the first partial store, in other words, installed in it as is customary without the interposition of a charging circuit. The background store is then connected via a charging circuit on the storage capacitor—e.g. in a parallel connection. In other words, the charging circuit is between the converter with the storage capacitor and the background store. The converter then always and/or only accesses the energy in the background store via the charging circuit. This controls the charging and discharging of the background store.

In a variant of this embodiment the energy flow is automatically regulated such that a voltage on one of the partial stores is kept within a certain voltage range. E.g. the voltage on the storage capacitor is kept within a defined voltage range by charge balancing between and/or with the other partial stores. A voltage reduction on the storage capacitor will e.g. occur if the load requires active power.

In a variant of this embodiment the energy storage arrangement also has a control device. This controls the charging circuit with regard to the energy flow between the partial stores separated by the charging circuit, wherein control takes place in response to a request from the load and/or the supply network. Load requests may, for example, take place for active or reactive load compensation with regard to the load. Thus, the supply network is protected from the power fluctuations of the load and/or these are collected in relation to the network. A request from the supply network can, however e.g. serve to temporarily store transient excess power consumption peaks in the network in the energy storage arrangement and thus to use the energy storage arrangement on the network side through an energy supply company.

In an additional variant of the aforementioned embodiment a partial store with a low charging speed is connected in series downstream of a partial store with a higher charging speed in relation to the converter. The partial store with a higher charging speed closer to the converter can therefore respond especially rapidly to requests from the converter. Thus, for example, a conventional storage capacitor also directly available in the converter is supported. The partial store with a lower charging speed is in turn located downstream of the faster partial store and supports this in turn with regard to greater energy amounts in the medium or long term. Energy transfer between the storage capacitor and the second partial store then takes place via the first partial store or through this while the respective partial stores may each have their own charging circuits.

An alternative embodiment to the aforementioned is one in which two or more partial stores with different charging speeds are each connected separately parallel to the converter or for example to a conventional storage capacitor assigned to the converter. Both partial stores can then support the conventional storage capacitor directly.

In an additional embodiment the energy store comprises a capacitor store with a plurality of supercapacitors. As a rule, such a capacitor store is one of several partial stores which e.g. in addition support a conventional storage capacitor integrated into the converter. The capacitor store may then serve as a background store. A capacitor store may, however, also be connected directly to, or be integrated into the converter instead of a conventional storage capacitor, in other words without the interposition of a charging circuit. As a rule, the capacitor store is responsible or designed for the rapid provision of smaller amounts of energy, high power consumption peaks and many load cycles.

With the capacitor technology known today, for example based on double layer capacitors (DLC, also called supercapacitors), such power or energy compensation can be realized by a capacitor store.

In an additional embodiment the energy store contains a battery store with at least one battery. As a rule, the battery store is also one partial store among many, in particular as a background store with large overall capacity and moderate power consumption peaks as well as a relatively low number of load cycles. A corresponding battery store may, for example, have several 1000 farads of storage capacity in order, for example, to be able to provide an output of two megawatts for ten minutes. This applies, for example, to a battery store with 600V. Thus, the load can be operated either solely from the partial store or also partly from the network with support from the partial store. In the latter case, the load on the voltage supply network is reduced.

In an additional embodiment of the energy storage arrangement, not only a single converter but several which can be individually controlled are interposed between the connections, as a rule connected in series. At least one of the converters is designed in the spirit of the proposal, in other words, equipped with one energy store in each case. Such converter topology is also called a multilevel converter, the converters and their charging circuits are e.g. each controllable individually. The structure of the respective converters or energy stores may be the same or different for several converters.

An additional important part relates to the isolation of the function of the converter and the respective storage levels, i.e. the partial store in the energy store. Isolation takes place by individual control of the charging circuits assigned to the partial stores. The aforementioned multilevel topology of converters can also be used without seriously altering the converter control itself, in other words, for example, with regard to the control of the valves in the H-bridge.

There are substantial advantages in that the proposed configuration enables a high-power application in steelworks. If a standard multilevel converter with a conventional intermediate circuit capacitor is expanded, the dynamic active load variation of an arc furnace can be largely compensated.

With regard to the alternating load consumer, the object is achieved by an alternating load consumer which is fed as a load by an energy supply network and to which an energy storage arrangement is assigned in the sense of an alternating load consumer system. In particular, for alternating load consumers, e.g. arc furnaces or rolling mill drives, the aforementioned energy storage arrangement is particularly useful both for collecting their high-frequency power consumption peaks—for example, in a capacitor store—and protecting the network as well as its permanent energy requirement during a process (e.g. smelting/rolling)—for example, from a battery store—via the converter and thus requiring less energy from the supply network.

In a preferred embodiment the alternating load consumer system or the energy store has active and/or reactive power fluctuations which are high in frequency in relation to the customary process duration in the alternating load consumer. This is, for example, the aforementioned flicker in the millisecond range for an arc furnace. The energy store is then designed in such a way that it compensates the supply network for at least a relevant part of the high-frequency active or reactive power fluctuations. A relevant part can be seen, for example, in the higher single-digit or in the double-digit percentage range. It is advisable to compensate almost completely for the aforementioned high-frequency fluctuations, for example, by at least 60% or 80%, so that only a small proportion of the power fluctuations reaches the supply network at all.

In an additional embodiment the energy store in the alternating load consumer system is designed such that it provides at least a relevant part of the entire active or reactive power required by the alternating load consumer during a process period. In other words, relevant support of the continuous output to the network takes place here. The percentage shares are to be understood as above with regard to relevance. For example, more than 10% of the active power required for the process in the arc furnace is provided from the energy store. For example, the installed power of the alternating load consumer system to the supply network can be reduced here, although the alternating load consumer itself has a higher output, and the differential power is provided from the energy store.

With the combination of different types of storage and simultaneous charging and/or discharging management the following energy storage system is created, for example, which when operated to optimum effect using medium voltage fulfills the aforementioned requirements: the arrangement comprises a mains side of an intermediate circuit converter of any design, and a downstream arrangement with double layer capacitors and their charging/discharging system. An arrangement with storage batteries with an additional charging/discharging system is in turn located downstream of the double layer capacitors.

The conventional intermediate circuit capacitor in known technology also contained in the intermediate circuit converter provides a high current variation. Connected to the intermediate circuit capacitor is the double layer capacitor charging system which charges downstream double layer capacitors to a voltage which need not be identical to the capacitor voltage. The charging/discharging function of the double layer capacitor is linked to a voltage window of the intermediate circuit capacitor. If the voltage of the intermediate circuit capacitor is too low, the double layer capacitors feed the intermediate circuit capacitor to increase its voltage. If the voltage of the intermediate circuit capacitor is too high, the double layer capacitors are charged from it.

In addition, there is a charging request for the battery system located downstream. When the respective charging limit of the double layer capacitors and the batteries is reached, overcharging by these charging circuits is prevented.

An additional battery charging device is connected to the double layer capacitors which charges the batteries located downstream. The battery voltage is selected by connecting individual cells in series; they need not necessarily correspond to the voltage on the double layer capacitors either. The charging/discharging function of the battery is only partially connected to a voltage window of the double layer capacitor voltage. The charging request for the battery can namely also be forwarded directly to the double layer capacitor charging device to optimize the charging process of the batteries making use of the interposed double layer capacitors and the battery charging device. The charging characteristic of the batteries is considerably slower compared to the charging of the double layer capacitors. Charging and discharging are undertaken, for example, on a project-specific basis, i.e. as a function of the load to be supplied and as a function of the energy storage technologies used. For example, a lithium-ion store must not be discharged completely if a high number of charge cycles is to be achieved.

In addition, the converter control may have an external interface. This receives, for example, information about the active/reactive power of a strongly fluctuating current flowing in the load. An active power consumption peak is then limited, for example, by intervention by the converter control in the charging devices, i.e. by the storage capacity of the double layer capacitors; these are in particular rapid processes.

Alternatively an average active power value for the energy consumption of the load can be predetermined, thus a smart-grid function can be realized in relation to the network and the energy requirements from the network restricted to a plant containing the load.

Through additional activation of the charging circuits, excess regenerative energy generated in the energy supply network can also be stored temporarily in the energy storage arrangement. An external interface of the converter control also receives, for example, information from the energy supply company to request or generate an active load realized by charging the energy store in order to stabilize the network. In this way a so-called standby function of the energy storage arrangement is implemented.

In addition, the external interface of the converter control can obtain information from a plant containing an energy-generating “negative” load. Here too an active load may be requested to stabilize the network in order to collect an energy amount generated by the load in the sense of an active load, if the network has no active power acceptance capacity or the connection to it is interrupted (e.g. in the case of load shedding). This is also a standby function of the energy storage arrangement.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an arc furnace with energy store

FIG. 2 shows an alternative energy store with partial stores connected in parallel,

FIG. 3 shows a multilevel converter with energy stores,

FIG. 4 shows an alternative multilevel converter,

FIG. 5 shows an additional alternative multilevel converter.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

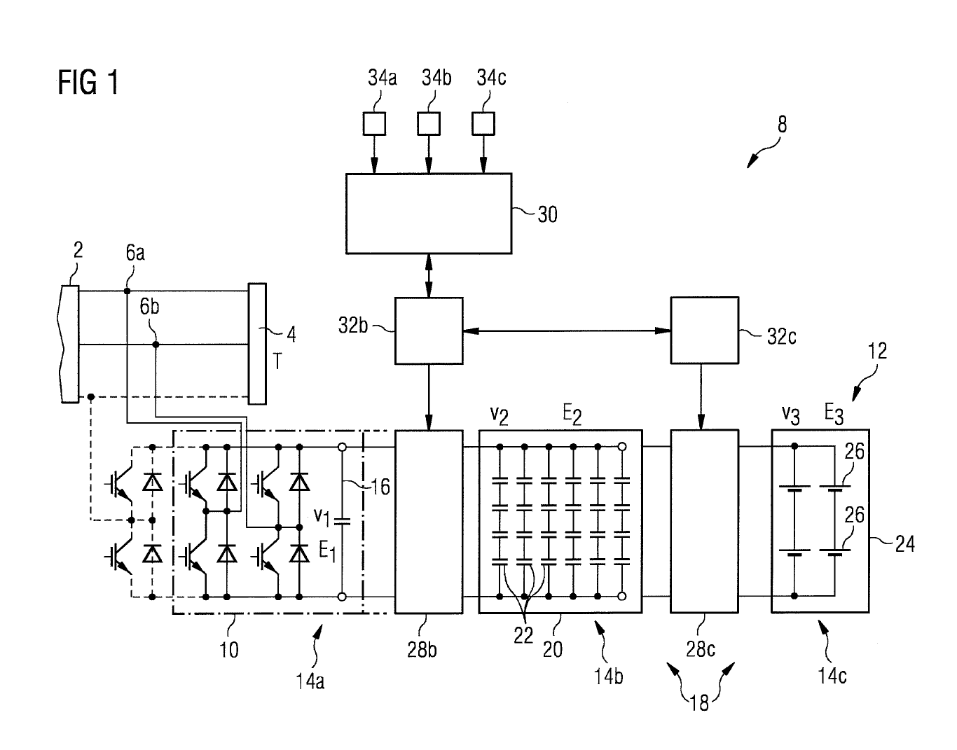

FIG. 1 shows a load 4 fed by an energy supply network 2, in the example an arc furnace. An energy storage arrangement 8 is connected in parallel to the energy supply network and the load 4 via two connections 6a, b.

The energy storage arrangement 8 has a voltage-impressed converter 10 connected between the connections 6a, b. The converter 10 contains an energy store 12. The energy store 12 comprises various partial stores 14a-c, which in total are designed to store an energy amount E1+E2+E3, which exceeds an energy amount necessary for the regular operation of the converter 10 by a multiple.

For simplification, only a two-phase arrangement is shown in the drawing. The overall arrangement may, however, also have three or more phases, as indicated by the dotted line in FIG. 1 solely in representational form for the load 4, the energy supply network 2 and the converter 10.

The first partial store 14a is formed by a conventional storage capacitor 16 of a standard converter. The storage capacitor 16 can only store a first energy amount E1, which is approximately in the range of that necessary for the regular operation of the converter 10. The partial store 14a is directly integrated into the converter 10, in other words corresponding to a conventional storage capacitor directly and permanently connected to the switching valves of the converter 10 shown.

The partial store 14b and 14c together form a background store 18. The partial store 14b is a capacitor store 20 which contains a plurality of supercapacitors 22. The capacitor store 20 stores an energy amount E2 which already exceeds the energy amount E1 by a multiple on its own.

The partial store 14c is a battery store 24, which contains a plurality of batteries 26. The energy amount E3 which can be stored in the battery store 24 in turn exceeds the energy amount E2 by a multiple.

The partial stores 14a-c each have a charging speed V₁_{_{—}}₃. This is greatest for the partial store 14a, smaller for the partial store 14b and smaller again for the partial store 14c. The partial store 14c with the lowest charging speed V₃ is therefore connected in series downstream of the partial stores 14a and 14b with the greater charging speeds V1 and V2 respectively seen in relation to the converter 10. The same applies between the partial stores 14a and 14b.

A charging circuit 28c is assigned to the partial store 14c, and controls its charging and discharging. A charging circuit 28b is also assigned to the partial store 14b, which controls both its charging and discharging as well as that of the partial store 14c on account of cascading. The charging circuits 28b,c are realized by charging devices. The charging circuit 28b therefore regulates the energy flow between the partial stores 14a and 14b or 14c, the charging circuit 28c the energy flow between the partial stores 14b and 14c. Power control of the electric currents flowing between partial stores 14a-c takes place in the respective charging circuits 28b,c.

In addition, the energy storage arrangement 8 comprises a control device 30 in the form of a converter control device which recognizes the charging characteristics 32b,c of the respective partial stores 14b and 14c and controls the respective charging circuits 28b and 28c accordingly. The charging characteristic 32b contains both those for the capacitor store 20 and for the battery store 24. The charging characteristic 32c is that of the battery store 24 alone.

The control of the charging circuits 28b,c takes place automatically. To this end, the voltage on the storage capacitor 16 is kept within a defined range by charge balancing between the partial stores 14a,b,c. A voltage reduction will occur if the load 4 requires active power. Alternative criteria are also conceivable.

Alternative or additional control of various requests 34a-c takes place. The request 34a in the example originates from and/or is occasioned by the energy supply network 2 and signifies the request to transport at least a part of the energy amount E2,3 to the energy supply network 2 in order to provide network support via the active power transferred accordingly.

The request 34b likewise originates from the energy supply network 2 and is used to exchange the energy amounts E1, E2 and E3 with the load 4 or any other load in a plant network, e.g. a rolling mill. Plant network stabilization is thus performed with regard to the energy supply network 2.

On the other hand, the request 34c originates from the load 4 and is intended to bring about a balance of power for rapid dynamic load fluctuations, e.g. a flicker occurring in the arc furnace, through a rapid exchange of energy E2 with the load 4 so that the load fluctuations are not transferred to the energy supply network 2.

In the example, smelting of steel scrap to form steel takes place in the arc furnace 4, with a process duration T of approximately ten minutes. In relation to this process duration, high-frequency active and/or reactive power fluctuations in the millisecond range take place in the arc furnace. The partial store 14b with its energy amount E2 is designed in such a way that it can suppress at least a relevant part of these high-frequency active and/or reactive power fluctuations to the energy supply network 2.

The partial store 14c is in turn designed in such a way that its energy amount E3 is sufficient to provide a relevant part of the required active and/or reactive power for the arc furnace 4 for the entire duration of the process, i.e. approximately 10 minutes, so that this energy does not need to be taken from the energy supply network 2.

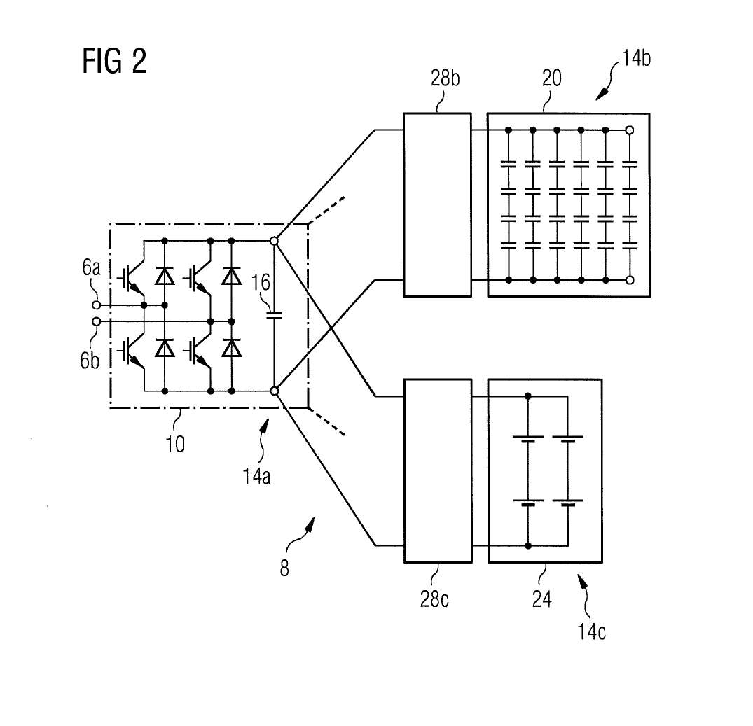

FIG. 2 shows an alternative embodiment of an energy storage arrangement 8. The partial stores 14b and 14c in the form of the capacitor store 20 and the battery store 24 together with the charging circuits 28b,c assigned to them are each individually connected in parallel to the first partial store 14a in the form of the storage capacitor 16. This is in contrast to their cascaded series connection according to FIG. 1. In FIG. 2 the respective currents flowing between the partial stores 14a and 14b and/or between the partial stores 14a and 14c are independent of each other. These therefore bring about charging or discharging of the partial stores 14b,c independently of each other. In other words, a charging current for the partial store 14c need not necessarily also flow through the partial store 14b or at least through its charging circuit 28b, as in FIG. 1.

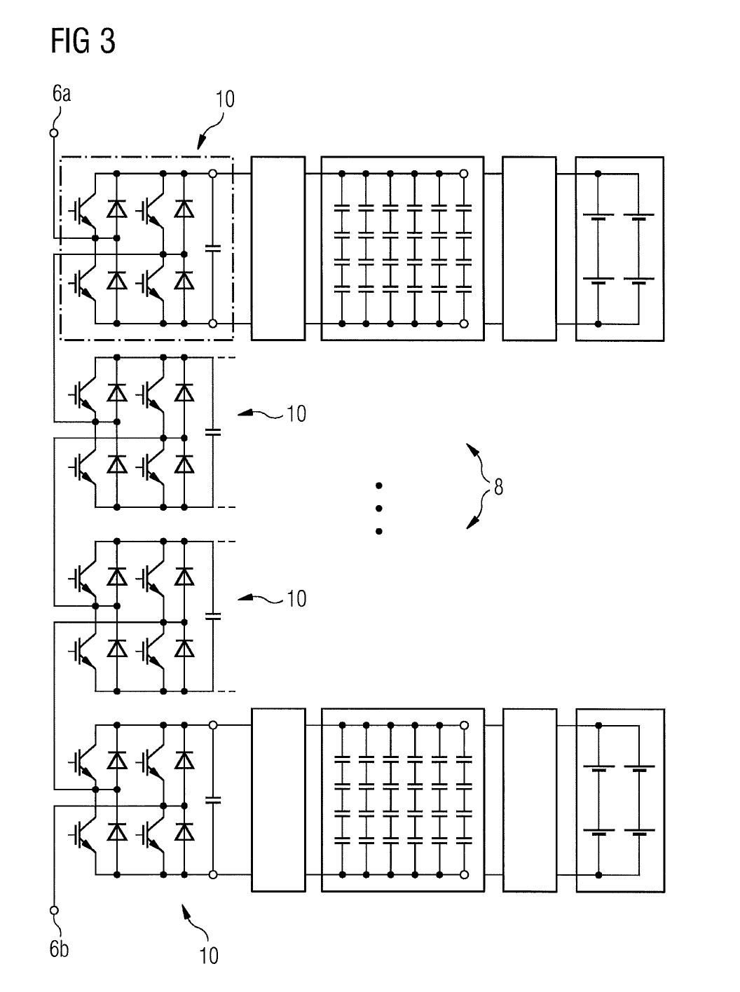

FIG. 3 shows a so-called multilevel converter. Here several converters 10 are connected in series between the connections 6a,b. Each of the converters here is equipped with a corresponding energy storage arrangement 8 identical to FIG. 1. However, different embodiments of the individual converters 10 and/or their energy storage arrangements 8 are also possible. The respective converters 10 can be connected individually.

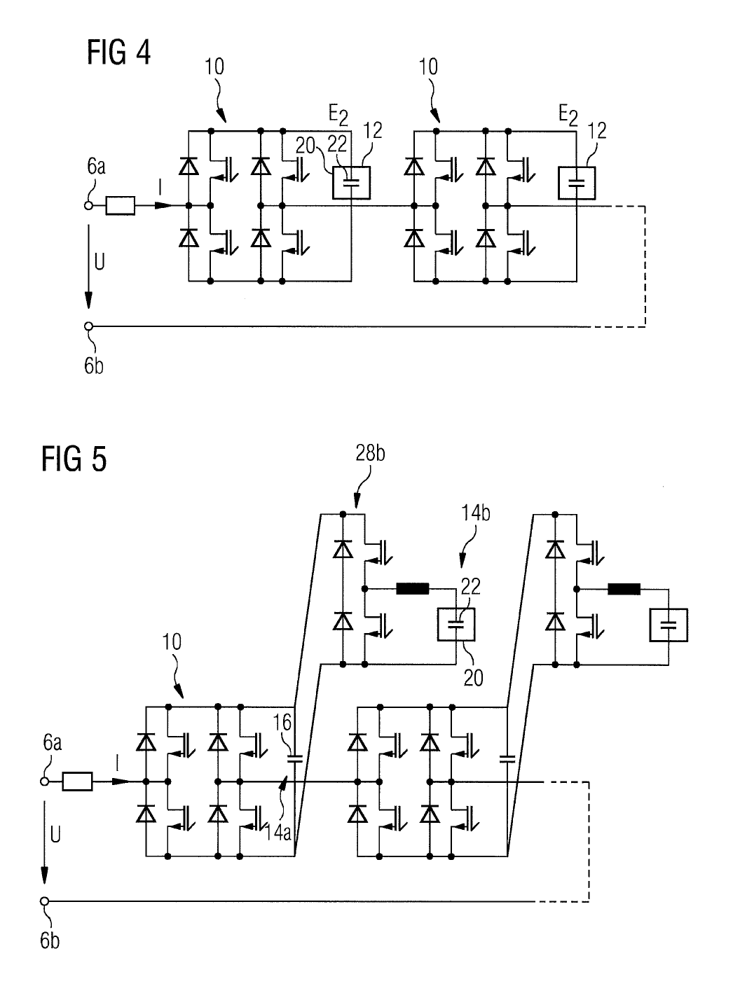

FIG. 4 shows an alternative multilevel converter with several individual converters 10 which are in turn connected in series between the connections 6a,b. Only two converters are shown, typically up to 46 converters 10 are connected in series here. For a complete multilevel converter with three phases, wherein FIG. 4 shows an arrangement for one phase, up to 138 modules with a partial intermediate circuit voltage of up to 2000 V are then connected in series. The partial intermediate circuit voltage is on the respective energy stores 12.

In addition, as an alternative embodiment of the energy store 12, FIG. 4 shows one such which only contains a capacitor store 20 comprising supercapacitors 22, of which only one is shown in representational form in FIG. 4. The energy store 20 here, comparable to the storage capacitor 16 in FIGS. 1-3, is directly connected in the converter 10, i.e. without interposition of a corresponding charging circuit. In other words, instead of the usual high-voltage intermediate circuit capacitors in the order of magnitude of millifarads, in this embodiment double layer capacitors are used directly as supercapacitors 22 each with a high capacity of between 100-3000 farads. Alternatively, however, a conventional intermediate circuit capacitor can also be directly connected in parallel to these.

The stored energy thus available quickly and at short notice can be provided with high output and used to compensate for active and reactive power.

For the direct connection of the capacitor store 20 in the converter 10, the maximum inductance of the connection, e.g. a low-inductance busbar, and the short-circuit power—fuses must be introduced here—must be observed. For a direct connection, in addition to the intermediate circuit capacitors the capacitor store 20 with inductances and fuses must be isolated. The usable energy E2 in the capacitor store 20 is determined here according to E=½ C (Umax²-Umin²) as per the voltage range of the intermediate circuits and is thus restricted.

FIG. 5 shows an alternative embodiment of FIG. 4 in which according to FIG. 1 a storage capacitor 16 is directly connected as a partial store 14a in the converter 10. In addition, according to FIG. 1 a partial store 14b in the form of a capacitor store 20 is assigned to the partial store 14a via a charging circuit 28b, here in the form of a buck and/or boost converter (DC/DC chopper). This enables the use of a greater capacitor voltage range and as a result, as per the equation E=½ C (Umax²-Umin²), the use of greater energy. For the embodiment of the capacitor store 20 according to FIG. 5 fewer supercapacitors 22 can therefore be used than in the variant according to FIG. 4. However, greater component expenditure is required on account of the charging circuit 28b: here, for example, a converter branch with its own regulation and a chopper choke is necessary. However, the actual converter 10 and/or its H-bridge remain unaltered.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-9. (canceled)

10. An energy storage arrangement for an electric load that exchanges electrical power with an energy supply network, the energy storage arrangement comprising:
at least two connections providing parallel connection between the load and the energy supply network; and
a voltage-impressed converter connected between the at least two connections, the voltage-impressed converter including an energy store,
wherein the energy store is configured to store an energy amount that exceeds an energy amount necessary for regular operation of the voltage-impressed converter by a multiple,
wherein the energy store includes a plurality of partial stores having different charging speeds from each other and having storage capacities for different energy amounts,
wherein the energy store includes a conventional storage capacitor as a first partial store of the plurality of partial stores and a background store including two or more additional partial stores of the plurality of partial stores, wherein the storage capacitor is configured to store a first energy amount that is in a range of the energy amount necessary for the regular operation of the converter, and the background store is configured to store a second energy amount that exceeds the first energy amount by a multiple,
wherein the first partial store is directly integrated into the converter and a charging circuit is connected between the first partial store and one of the two or more additional partial stores, the charging circuit being configured to control an energy flow between the plurality of partial stores, and
wherein, among the plurality of partial stores, a partial store with a lower charging speed is connected in series downstream of a partial store with a higher charging speed in relation to the converter.

11. The energy storage arrangement as claimed in claim 10, wherein an energy flow is automatically regulated such that a voltage is kept within a certain voltage range on one of the plurality of partial stores.

12. The energy storage arrangement as claimed in claim 10, further comprising a control device controlling the charging circuit with regard to an energy flow at the request of the load and/or the energy supply network.

13. The energy storage arrangement as claimed in claim 10, wherein the energy store includes a capacitor store with a plurality of supercapacitors.

14. The energy storage arrangement as claimed in claim 10, wherein the energy store includes a battery store with at least one battery.

15. The energy storage arrangement as claimed claim 10, further comprising a plurality of converters, each converter being individually controllable and connected in series between the connections and having respective energy stores.

16. An alternating load consumer, which is fed by the energy supply network as the load, with an energy storage arrangement as claimed in claim 10.

17. The alternating load consumer as claimed in claim 16, which in relation to a process time of the alternating load consumer has high-frequency active and/or reactive power fluctuations, wherein the energy storage arrangement compensates the energy supply network for at least a relevant part of the high-frequency active and/or reactive power fluctuations.

19. The alternating load consumer as claimed in claim 16, wherein the energy storage arrangement provides at least a relevant part of the total active and/or reactive power required by the alternating load consumer during a process time.

20. An energy storage method for an energy storage arrangement including an electric load that exchanges electrical power with an energy supply network, the energy storage method comprising:
providing at least two parallel connections between the load and the energy supply network;
connecting a voltage-impressed converter between the at least two connections; and
storing, in an energy store of the voltage-impressed converter, an energy amount that exceeds an energy amount necessary for regular operation of the voltage-impressed converter by a multiple,
wherein the energy store includes a plurality of partial stores having different charging speeds from each other and having storage capacities for different energy amounts,
wherein the energy store includes a conventional storage capacitor as a first partial store of the plurality of partial stores and a background store including two or more additional partial stores of the plurality of partial stores, wherein the storage capacitor is configured to store a first energy amount that is in a range of the energy amount necessary for the regular operation of the converter, and the background store is configured to store a second energy amount that exceeds the first energy amount by a multiple,
wherein the first partial store is directly integrated into the converter and a charging circuit is connected between the first partial store and one of the two or more additional partial stores, the charging circuit being configured to control an energy flow between the plurality of partial stores, and
wherein, among the plurality of partial stores, a partial store with a lower charging speed is connected in series downstream of a partial store with a higher charging speed in relation to the converter.
